(19) United States
(12) Patent Application Publication
(10) Pub. No.: US 2008/0251578 A1
(43) Pub. Date: Oct. 16, 2008

(54) ATM SECURITY SYSTEM AND METHOD OF USE

(76) Inventor: Nicholas E. Jansing, Reno, NV (US)

Correspondence Address: LONG & CHYBIK, 1575 DELUCCHI LANE, SUITE 32, RENO, NV, 89502, US

(21) Appl. No.: 12/101,144

(22) Filed: Apr. 10, 2008

Related U.S. Application Data
(60) Provisional application No. 60/922,777, filed on Apr. 10, 2007.

(51) Int. Cl. G07F 19/00

(52) U.S. Cl. 235/379

(57) ABSTRACT

One possible embodiment of the invention could be an ATM security system comprising of an ATM, an ATM alarm system, a financial institution computer system is connected to the ATM and the ATM alarm system, and a security code that when entered by the individual into the financial institution computer system through the ATM will cause the financial computer system to active the ATM alarm system relative to the ATM.

### CROSS-REFERENCES TO RELATED APPLICATIONS

This application claims the benefit under 35 U.S.C. §119(e) of U.S. Provisional Patent Application No. 60/922,777, filed on Apr. 10, 2007, contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to security systems for financial institutions. More specifically, the present invention may be related to security systems for ATMs of financial institutions.

### BACKGROUND

Many financial institutions that provide ATMs (e.g., Automatic Teller Machine) for the use of their patrons (and other persons authorized to do so by the patrons) and, in a reciprocal manner, for authorized patrons of other financial institutions. These ATMs can generally allow a patron to electronically access their financial accounts twenty-four hours a day to withdraw funds, make deposits, and conduct financial transactions. To access his or hers accounts, a patron generally needs to activate the ATM through a protocol specified by the financial institution running the ATM or by an independent contractor servicing the ATM upon the financial institution's behalf. Generally, such a protocol could include presentment to the ATM of an ATM card (or like card) and a PIN (e.g., Personal Identification Number). The presentment of the ATM card (or alike) could include inserting or swiping the ATM card into a card reader of the ATM to allow the ATM to read the stored data on the card. After the ATM reads the stored data, it can then access the financial institution's computer system in order to identify which financial accounts can be properly accessed at that time. The ATM could then prompt the individual to present (e.g., enter through the ATM key pad) the PIN. Only if the correct PIN is entered, could the ATM be used to allow the individual to use the ATM to conduct financial transactions with authorized accounts via the financial institution's computer system.

To protect such valuable services, the financial institutions the ATMs with ATM alarm systems. Generally such alarm systems protect only the ATMs themselves and not the individuals using them. These ATM alarm systems can generally detect unauthorized persons attempting to damage or otherwise break into the ATM itself (e.g., breaking into the backside area of the machine where the funds are stored to be dispensed out by the ATM.) Upon such detection, the ATM communicates to the computer system of the financial institution that is responsible for the ATM. The financial institution's computer system then activates the ATM alarm system for the respective ATM. The ATM alarm system, once activated, can contact security personnel (e.g., law enforcement), inform the security personal that unauthorized actions have taken place at the ATM, the location of the ATM, and then generally request that the security personnel to go to the location of the ATM.

Since their general introduction in the 1970's, ATMs and their usage have become so widespread that their services are accepted as part of a normal part of life. Accordingly, crime has also adjusted to take advantage of such services as well. With greater frequency, individual using ATMs are becoming robbery victims whereby criminals, either under the duress of the threat of physical bodily harm or otherwise, force the patron to activate the ATM (presenting the ATM card and PIN to the ATM) or to otherwise obtain the ATM card and PIN from the patrons, by which to illegally access and remove funds from the patron's financial accounts.

Currently, ATM alarm systems generally do not help combat such crimes other than providing for historical services such as passive video recordation of transactions conducted at the ATM. They do not allow for patrons or other authorized persons, who are subjects to such ATM robberies to activate the ATM alarm systems to summon for help when they are being forced, against their will, by criminals to access their accounts. Such ATM systems generally do not provide for the unwitting activation of ATM alarm systems by unauthorized persons or the criminal element when they attempt unauthorized withdrawals from ATMs.

What is needed therefore is an ATM security system that can activate an ATM alarm system through the use of ATM by individuals.

### SUMMARY OF ONE EMBODIMENT OF THE INVENTION

### Advantages of One or More Embodiments of the Present Invention

The various embodiments of the present invention may, but do not necessarily, achieve one or more of the following advantages:

provide an individual interacting with or entering information into an ATM with the ability to activate the ATM alarm system;

the ability to summon security personnel to an ATM when the ATM is being used by an unauthorized individual to access financial accounts though the ATM;

provide an enclosure means of keeping an individual attempting unauthorized access of financial accounts through an ATM proximate to the ATM;

the ability to have an individual attempting an unauthorized access of financial accounts through an ATM unknowingly activate an ATM alarm system;

provide a visual means of enticing an individual attempting unauthorized access of financial accounts to interact with ATM until summon security personnel arrive at the ATM.

These and other advantages may be realized by reference to the remaining portions of the specification, claims, and abstract.

### Brief Description of One Embodiment of the Present Invention

One possible embodiment of the invention could be an ATM security system comprising an ATM, an ATM alarm system, a financial institution's computer system connected to the ATM and ATM alarm system, and a security code, wherein the security code is entered by the individual into the financial institution's computer system through the ATM and subsequently activates the ATM alarm system.

Another possible version could be a methodology of operating an ATM security system comprising of providing an ATM, providing a ATM alarm system; providing a financial institution's computer system that is connected to the ATM and the ATM alarm system, activating the ATM, and activating the ATM alarm system through the activation of the ATM.

Another possible version could be a methodology of operating an ATM security system comprising of providing an ATM, providing a ATM alarm system; providing a financial institution's computer system that is connected to the ATM and the ATM alarm system, activating the ATM; and activating the ATM alarm system by entering a security code into the financial institution's computer system through the ATM.

The above description sets forth, rather broadly, a summary of one embodiment of the present invention so that the detailed description which follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of the invention.

FIG. 2 is substantially a perspective view of one embodiment of the invention.

FIG. 3 is substantially a perspective cutaway view of one embodiment of the invention.

FIG. 4 is substantially a perspective cutaway view of one embodiment of the invention.

FIG. 5 is substantially a flowchart showing one embodiment for the process of operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments by which the invention may be practiced. It is to be understood that other embodiments may be utilized and structural changes may be made without departing from the scope of the present invention.

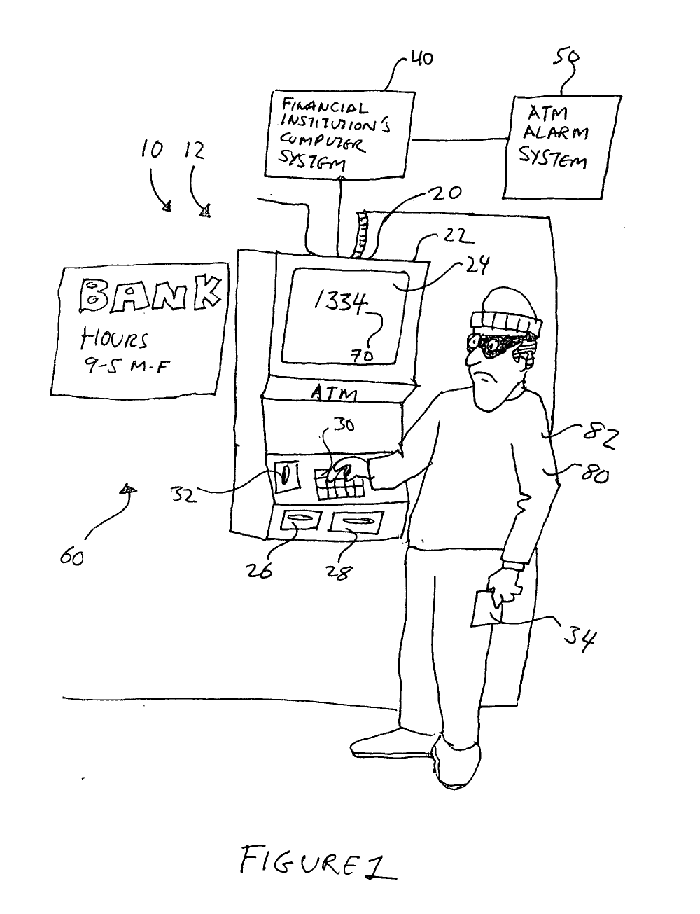

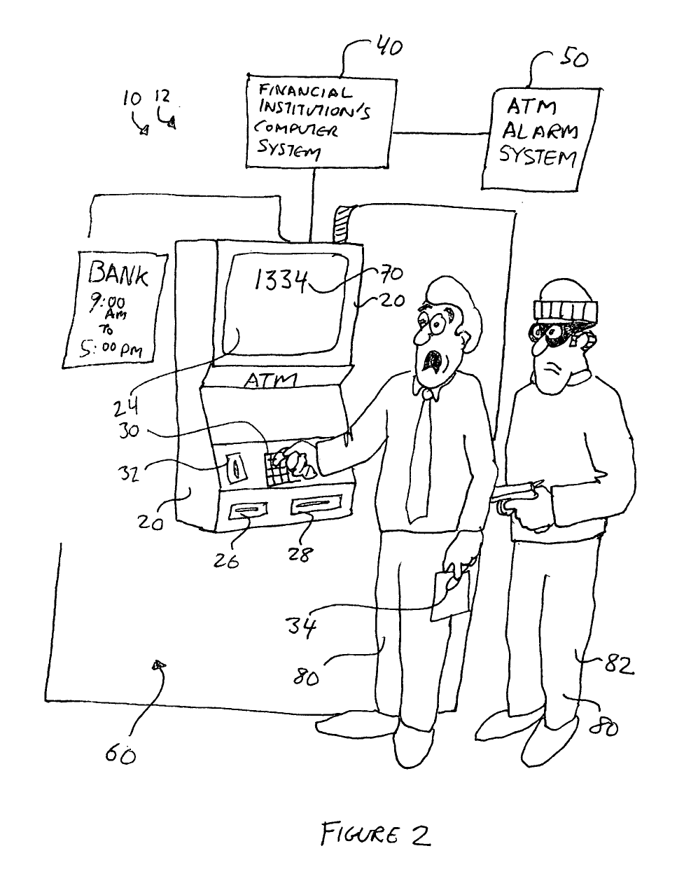

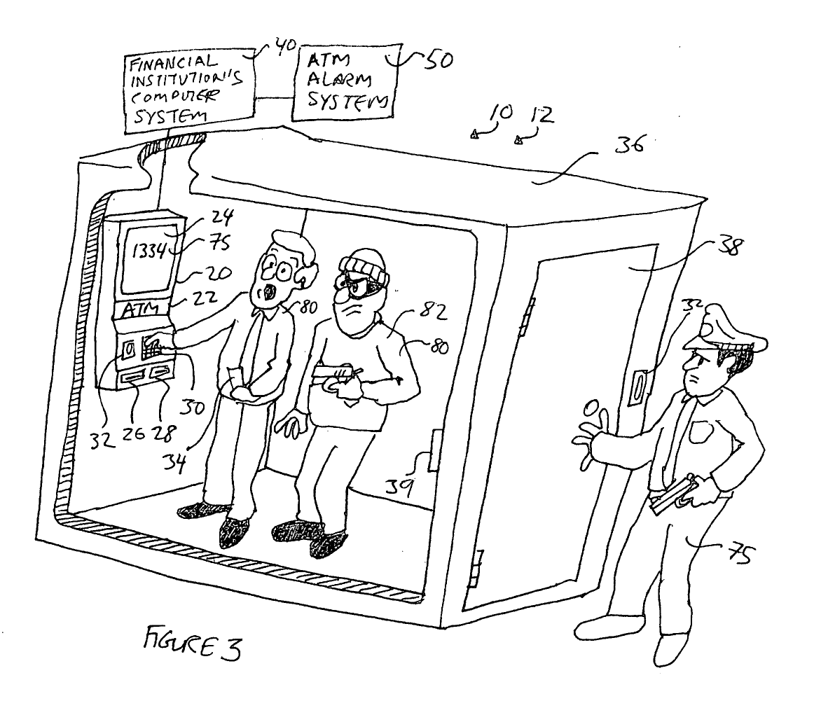

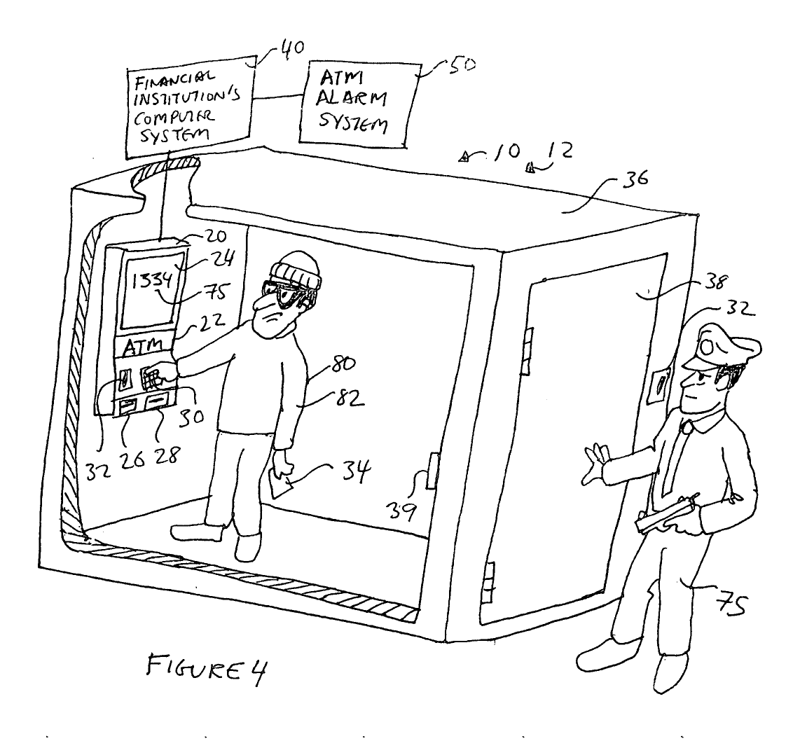

As substantially shown in FIGS. 1 through 5, the present invention 10 could comprise an ATM security system 12 and a process 100 of operating the ATM security system 12.

As substantially shown in FIGS. 1-4, the ATM security system 12 could be comprised of an ATM (Automatic Teller Machine) 20, a financial institution's computer system 40, an ATM alarm system 50, and a security code 60 that when presented to the ATM 20 could cause the activation of the ATM alarm system 50. The ATM 20 could be comprised of a body 22 generally containing all the components comprising the ATM 20. Some of the components could include, but not necessarily be limited to, a display screen 24, a cash dispensing means 26, a deposit accepting means 28, a key pad 30, and a card reader 32. In other versions, the ATM 20 could employ touch screen technology (e.g., Microsoft®'s SURFACE™ software system) whereby the function of a separate mechanical keypad 30 could be provided though the display screen 24 as well as the ability to scan the ATM card 34 for its stored data.

The ATM 20 could be located in the financial institution 60 (e.g., bank lobby, bank outsider teller bays, etc.) as well as areas generally remote from the offices of the financial institutions (e.g. kiosk stand alone structures, dedicated areas in non-financial institution venues such as stores, casinos, and other areas generally open to the public.)

The ATM 20 could also be located in a secure facility such as a room 36, whose access to the outside is secured by a door 38 that is electronically controlled (e.g., locked) by the financial institution's computer system 40. Such a room 36 could be the foyer (not shown) leading to the lobby (not shown) of the financial institution 60. During off hours, the connection between the foyer and lobby is barred while the electronically controlled door 38 allows access to the room 36 from the outside the financial institution 60. Generally, the door 38 has a push button/motion sensor 39 on the inside of the room 36 and a card reader 32. The card reader 32 for the door is generally separate from the one found on the ATM 20. The door card reader 32 could be located on the outside of the room 36 and can be electrically connected to the financial institution's computer system 40 to control the opening of the door 38. In such cases to gain admittance to the room 36, an individual 80 could swipe an ATM card 34 through the card reader 32. The financial institution's computer system 40 reading the stored data on the ATM card 34 through the card reader 32 could generally unlock or otherwise open the door 36 to allow an individual normal admission to the room 36 and to the ATM 20. Upon entering the room 36, the door 38 could shut behind the individual 80 and lock again. To leave the room 38, the individual 80 could set or activate the motion detector/electric button 39. The financial institution 60 upon receiving electronic signals from the motion detector/the electric button 39 could unlock or otherwise open the door 38 permitting egress from the room 36.

Generally, most ATMs 20 can access, through telecommunication means (e.g., dedicated land lines and the like), the financial institution's computer system 40 of the financial institution 60 responsible for ATM. In this manner, if the financial accounts being accessed through the ATM 20 belong to another financial institution 60, the financial institution's computer system 40 of the financial institution 60 responsible for ATM 20 can access the other financial institution's computer system 40 to access those financial accounts.

Although a financial institution 60 could have several IT systems, the term “financial institution's computer system” 40 here could substantially reference those IT systems of the financial institution 60 responsible for the ATM 20 to allow the ATM 20 to access financial accounts and connect the ATM 20 to the ATM alarm system 50.

To generally activate the ATM 20 (e.g., to access financial accounts of a financial institution 60) the individual, 80 such a patron of the financial institution or a duly authorized person could present in normal fashion, an ATM card 34 and a password (e.g., a PIN) to the ATM 20. The password (e.g., PIN) and ATM card data could be compared together by the financial institution's computer system 40. If the password is a PIN, and the PIN and ATM card data correlate, then the financial institution's computer system 40 could allow the individual 80 to access and conduct financial transactions with the financial accounts associated. If the PIN and ATM card data do not correlate, then the financial institution's computer system 40 could prompt the individual 80 through the ATM to re-enter the PIN or otherwise deny the individual 80 access to the desired financial accounts.

In the present invention, the financial institution 60 could further associate a security code 70 (along with the PIN) with the financial accounts whose data is stored on the ATM card 34. This security code 70 could be a numeric or alpha numeric password like the PIN (but of course, be different from the PIN such as the PIN could be 1234 and the security code 75 could be 1334). In this manner, the security code, which could be slightly but significantly different to the PIN could easily be called upon (e.g., remembered) by the financial institution patron (or other authorized individual) under stress, duress, and the like.

The programming of a current financial institution's computer system 60 could be altered by one having ordinary skill in the art to react to the presentment (e.g., keypad entry) of a security code to ATM 20. Once so altered, the individual 80 could present the ATM card 34 to the ATM (swipe/insert the ATM card 34 in the ATM card reader 32.) When the financial institution's computer system 60 has been so prompted through the ATM 20, the financial institution's computer system 60 could request (through the ATM 20) that the individual 80 present to the ATM, the password which the individual 80 (e.g., criminal element 82) thinks is the PIN. When the password (e.g., the security code 70) is presented instead and unwittingly to the ATM 20, the financial institution's computer system 40 compares the password with the identity data of the financial accounts associated with ATM card 34. If the password matches the security code 70 associated with the financial account(s) whose data is on the presented ATM card 34, the financial institution's computer system 40 could silently activate the ATM alarm system 50 in regards to the respective ATM 20.

In addition to activating the ATM alarm system 50, the financial institution's computer system 40 could be further programmed to deny the individual 80 access to any financial accounts through the ATM 20, particularly with those financial accounts associated directly with the ATM card 34. The financial institution's computer system 40 could also be programmed to set forth through the ATM 50 a set of messages (e.g., posted on the ATM display screen 24) that are designed to entice the individual 80 to continuously engage the ATM 20 and stay proximate to the ATM 20 (pending arrival of security personnel 75 being summoned by the ATM alarm system 50 to the ATM 20).

When the individual 80 (e.g., criminal element 82) enters a request for an amount of funds or money to be withdrawn from the financial account through the ATM 20, the financial institution's computer system 40 could cause the ATM 20 to display the message such as “INSUFFICIENT AMOUNT OF FUNDS, PLEASE TRY LESSER AMOUNT” regardless of the actual amount of funds requested against the actual amount of funds available. The financial institution's computer system 40 could prevent the transfer or dispensing to the individual 80 of any funds from the financial account. These actions by the invention 10 could substantially prompt the individual 80 (by capitalizing on the individual's greed to get funds from the financial account) to repeatedly request withdrawals of lesser amounts of funds.

As the individual 80 complies with the messages and requests a sequentially slightly lesser amounts (again the invention 10 is capitalizing on the individual's greed to get most amount of funds from the financial account), the invention 10 could repeat the same enticing messages. This cycle of messages could be repeated regardless of the actual amount of funds asked for or the actual amount of funds available in the account. This cycle of presenting such messages (accompanying with the individual's continuing requests for lesser amounts of funds from the financial accounts) could possibly delay the individual 80 from leaving the ATM area by enticing the individual with the hope of actually getting funds (e.g., such as how gambling works with a slot machine) until the security personnel 75 have arrived at the ATM 20 to detain the individual 80 (or if the patron is activating the ATM, other individuals 80 [criminals 82] who are robbing the patron.)

The repeated cycle of messages and denial of payment from the financial account could also be set to processed at a speed that could balance the need to avoid frustrating the individual 80 (and having the individual 80 leave ATM area before summoned security personnel 75 have arrived at the ATM) with the need to give enough time to the security personnel 75 to arrive at the ATM 30.

If during the cycle, the individual 80 attempts to check the balance of the financial account, the financial institution's computer system 40 could be programmed to have the ATM 20 display the message such as “BALANCE IS CURRENTLY UNAVAILABLE” regardless of the actual status of the check balance function for that financial account.

In this manner, the greed of the individual 80 to access the financial account could drive the individual 80 to repetitively and futilely attempt to get a funds withdrawal amount acceptable to the financial institution's computer system 40. In this manner, the invention 10 could entice the individual to remain proximate to the ATM generally until security personnel 75 summoned by the ATM alarm system have arrived at the ATM to detain and possibly interrogate the individual about its activities.

The ATM alarm system 50 could be comprised of set of systems that handle and monitor ATM performance/non-performance, intruder detection, and other security issues. Such systems could work independently or together to handle matters such as passive video recordation of transactions, detection of unauthorized mechanical penetration of the body, damage/vandalism being done to the ATM 20, notifying security personnel 75 to go to the ATM regarding damage and vandalism to the ATM 20.

Generally, the various types of ATM alarm systems 50 are connected to the financial institution's computer system 40. The ATM alarm systems 50 are generally triggered by the activities of individual(s) trying to break into and access the interior of the body 22 (to obtain funds stored therein) or vandalizing the exterior of the body 22. In such a type of ATM alarm system 50, sensors (not shown) placed in or proximate to the body 20 could detect the actions of individuals 20 generally proximate to the ATM, those actions capable of being interpreted as damaging the ATM 20. Generally, current ATM alarm systems 50 are not set to be activated or triggered by any individual 80 activating the ATM 20 to access financial accounts or conduct other financial matters through the ATM 20 (whether authorized or unauthorized accessing of financial accounts; or accessing is occurring under criminal duress or threat of bodily harm).

In the present invention, when the financial institution computer system 40 detects the entry through an ATM 20 of a password that is a security code 70 assigned to the financial account(s) that are attempted to be accessed through the ATM 20, the financial institution's computer system 40 could then activate the ATM alarm system 50 as it relates to the respective ATM 20. Once activated, the ATM alarm system 50 could be in silent mode to generally prevent the individual 80 activating the ATM 20 from realizing that the ATM alarm system 50 has been triggered, from wanting to leave the ATM area, from realizing the messages displayed on the ATM 20 may not be accurate, from wanting to continue to attempt to get funds from the financial accounts through the ATM 20. The ATM alarm system 50 could cause the communication of information to be transmitted to security personnel 75 (e.g., law enforcement) 75 regarding the location of the ATM 20 and that there is an unauthorized attempt to access financial account through the ATM 20 (e.g., crime in progress).

Once the summing of police communication is established, ATM alarm system 50, could have the financial institution's computer system 40 (if the ATM 20 is located in a room 36 whose access is controlled by a door 38 electronically operated by the financial institution's computer system 40) go into a “fail secure” mode for the door 38. This could involve electronically cutting power to the door 38 thereby causing the door 38 to close and lock, sealing off access to the room 36. Once security personnel 75 are upon the scene, the ATM alarm system 50 could open the door 38 (e.g., leave “fail secure” mode) and allow security personnel 75 access to the room 38 and detain and interrogate the individual 80.

Methodology

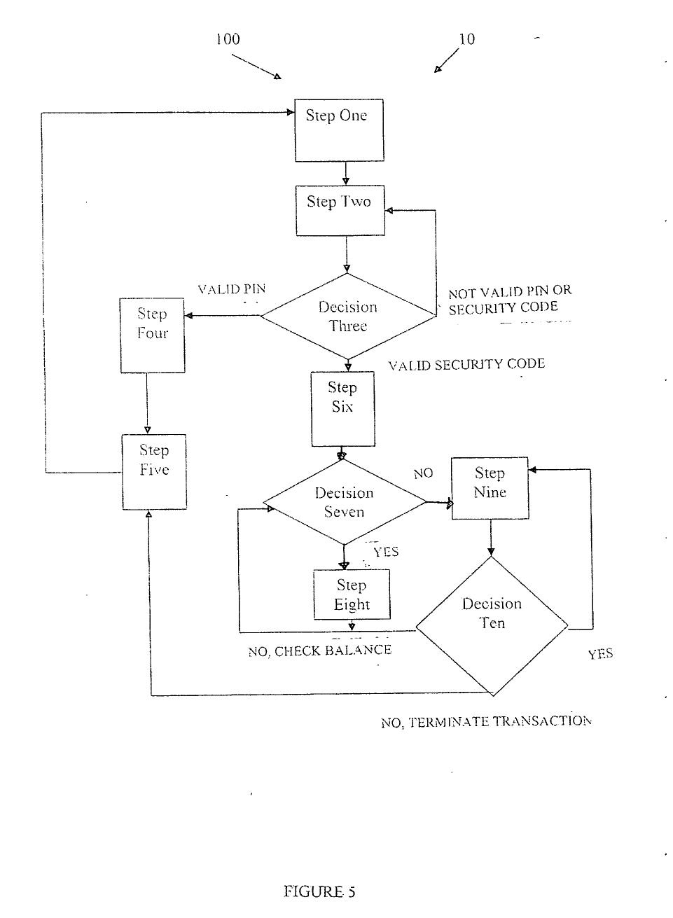

As substantially shown in FIG. 5, the process 100 of activating an ATM security system could commence with step one, presentment of the ATM card. In this step, an individual (e.g., criminal, patron acting under criminal's instructions and the like) could present the ATM card or the like to the ATM (e.g., swipe or insert the ATM card into the card reader.) The financial institution's computer system through the ATM could read the stored data on the ATM card or the like to determine which financial accounts could be properly accessed through the presentment of the ATM card or the like. Upon substantial completion of step one, the process 100 could generally proceed to step two, presentment of the password.

At step two, the presentment of the password, the process 100 could have the financial institution's computer system through the ATM prompt the individual to present to the ATM the password to access the desired financial accounts (e.g., those associated with the ATM card). The individual could make this presentment by entering the password via the ATM keypad or other suitable means.) The financial institution's computer system would then compare the password with the PIN and security code associated desired financial accounts. Upon the substantial completion of step two, the process 100 could generally proceed onto decision three, matching or not matching.

At decision three, matching or not matching, the financial institution's computer system decides whether the password matches or does not match either the security code or the PIN. If the password does not match either the PIN or the security code, the process 100 can proceed back to step two, presentment of password. If the password matches the security code, then the process 100 can generally proceed to step six, activating the ATM alarm system. If the password matches the PIN, the process can generally proceed to step four, to conduct financial transactions.

At step four, conduct financial transactions, the financial institution's computer system allows the individual to access through the ATM the appropriate financial account(s) and conduct proper financial transactions with the financial institution regarding the financial accounts. Upon substantial completion of step four, the process could proceed to step five, completion of financial transactions.

At step five, completion of financial transactions, the individual could undertake those actions needed to terminate access to the financial accounts through the ATM (e.g., press the “cancel transactions” button on the ATM display screen.) Upon substantial completion of step five, the process 100 could end or it could generally proceed at a later time back to Step 1, presentment of the ATM card, should the individual want to access financial accounts again through an ATM.

At step six, activate ATM alarm system, the financial institution's computer could activate the ATM alarm system. The ATM alarm system could operate in silent mode to avoid informing the individual that the ATM alarm system has been activated, the use of a security code during presentment, and that security personnel are in route to the ATM. The ATM alarm system could then summon security personnel to the ATM (e.g., communicating the location of the ATM, that unauthorized attempts of accessing financial accounts through ATM are being committed; and request security personnel presence at the ATM site, etc.) If the ATM is kept in a room whose access is controlled by an electronic door, the ATM alarm system could cause the door to close and lock to seal off access to the room. Upon substantial completion of step six, the process 100 could generally proceed to decision seven, check balance.

At decision seven, check balance, the individual could decide whether to decide to check the balance of the financial account that the individual wishes to access. If the individual decides not to check the balance, the process could proceed to step nine, attempt to withdraw. If the individual decides to check the balance, the process could proceed to step 8, balance unavailable.

At step eight, balance unavailable, the individual activates one or more of the selections presented by the ATM for obtaining a balance of available funds for the financial account that the individual desires to access. Once the individual has request the balance inquiry, the financial institution computer system, through the ATM, will display a message generally stating that the balance inquiry function is unavailable. This message will be displayed regardless of the true status of the balance inquiry function. After substantially completing this step, the process could proceed back to decision seven, check balance.

At step nine, attempt to withdraw, the individual could enter through the ATM a request with the financial institution's computer system to withdrawal a certain amount of funds from the desired financial account. The financial institution computer system, without regard to the actual amount of funds available in the financial account or requested for withdrawal by the individual, could cause the ATM to transmit (e.g., display) the message that there are insufficient funds in the financial account (e.g., and resubmit another withdrawal request for smaller amount of funds.) Once step nine is substantially accomplished, the process 100 could proceed to decision 10, request another withdrawal.

At decision 10, request another withdrawal, the individual could decide whether or not to attempt again to request a withdrawal of funds from the desired financial account. If the decision is made to make another attempt, the process 100 could proceed back to step nine, attempt to withdraw, to attempt to withdraw a smaller amount of funds than had been requested in the earlier request. In following this pathway, the invention is generally relying on the individual's (criminal's) greed to get the most funds from the financial account by only asking for a small reduction in amount to be withdrawn. In this manner, through incremental reductions in the requested amount, the individual is enticed to spend more time in this cycle or pathway, thus giving the security enforcement more time to arrive at the ATM.

If the individual decides not to request a smaller amount in funds to be withdrawn, the individual could proceed to step five, completion of financial transactions and end the transaction through the ATM (at which point the security personnel could possibly have arrived at the ATM) or the individual could proceed to decision seven, check balance, in a continued effort to obtain funds from the desired financial account.

Once the ATM alarm system has been activated, the invention 10 generally shields the desired financial accounts from access by the individual. The invention further attempts to present through the ATM, various communications unrelated to the actual status of the financial account or actual functioning of the financial account so as to generally entice the individual to substantially interact continuously with the ATM until the arrival of security personnel at the ATM.

Conclusion

As seen from the specifications, the invention does provide an individual using an ATM with the means (such as a security code) to activate the ATM alarm system; entices, through messages, an individual to interact with the ATM until summoned security personnel arrive at the ATM; the messages providing information on account and function status that may be unrelated to the actual account's and function's status.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. An ATM security system comprising:
(A) an ATM, the ATM connected to a financial institution's computer system;
(B) a financial institution's computer system, the financial institution's computer system having the capability of permitting an individual to use the ATM to access one or more financial accounts of a financial institution;
(C) an ATM alarm system, the ATM alarm system connects to the financial institution's computer system; and
(D) a security code, the security code activates the ATM alarm system relative to the ATM when the security code is entered by the individual into the financial institution's computer system through the ATM.

2. An apparatus of claim 1 wherein the ATM generates messages to entice the individual to interact with the ATM until arrival of security personnel summoned to the ATM.

3. An apparatus of claim 2 wherein the message, regardless of actual amount of funds available in the financial account or requested by the individual, sets forth that the financial account has an insufficient amount of funds.

4. An apparatus of claim 2 wherein the message, regardless of the actual status of the balance inquiry function, sets forth that the balance inquiry function is unavailable.

5. An apparatus of claim 2 wherein the security code is assigned to the financial account that the individual is trying to access.

6. An apparatus of claim 1 further comprising of a room that contains the ATM, the room further having a door that is electronically locked to seal the room the individual in the room when the ATM alarm system is activated.

7. A methodology of operating an ATM security system comprising of the following steps, but not necessarily in the order shown:
(A) providing an ATM that connects to a financial institution's computer system;
(B) providing the financial institution's computer system, the financial institution's computer system capable of allowing the ATM to be used to access one or more financial accounts of a financial institution;
(C) providing a ATM alarm system;
(D) activating the ATM to obtain unauthorized access to the financial account; and
(E) activating the ATM alarm system through the activation of the ATM.

8. A methodology of claim 7 wherein activating an ATM includes presenting to the ATM an ATM card and a security code, the security code being assigned to those financial accounts that are associated to the ATM card.

9. A methodology of claim 8 wherein the presentment of the ATM card and security code is by an individual not authorized to access the financial account associated with the ATM card.

10. A methodology of claim 8 wherein the presentment of the ATM card and security code is by an individual authorized to access a customer account, the individual acting under the threat of bodily harm.

11. A methodology of claim 7 further comprising of the step of directing security personnel to go to the location of the ATM to detain the individual activating the ATM.

12. A methodology of claim 7 further comprising of the step of displaying visual messages through the ATM to entice the individual to interact with the ATM until the arrival of security personnel at the ATM.

13. A methodology of claim 12 wherein the message is that the financial account has insufficient funds regardless of the amount of funds actually available in the financial account.

14. A methodology of claim 12 wherein the message is that the financial account has insufficient funds regardless of the actual amount of funds requested by an individual.

15. A methodology of claim 12 wherein the message is that the function that is providing the balance of the financial account is unavailable regardless of the actual status of the function.

16. A methodology of operating an ATM security system comprising of the following steps, but not necessarily in the order shown:
(A) providing an ATM that can accesses a financial institution's computer system;
(B) providing the financial institution's computer system, the financial institution's computer system capable of accessing of financial accounts of a financial institution;
(C) providing the ATM alarm system that is connected to the financial institution's computer system;
(D) activating the ATM; and
(E) activating the ATM alarm system by entering a security code into the financial institution's computer system through the ATM.

17. A methodology of claim 16 further comprising of the step of displaying visual messages through the ATM to entice the individual interact with the ATM until the arrival of security personnel at the ATM.

18. A methodology of claim 16 further comprising of the step of displaying a message on the ATM that the financial account has insufficient funds regardless of the actual amount of funds available in the financial account or the actual amount of funds requested by the individual.

19. A methodology of claim 13 further comprising of the step of displaying a message through the ATM that the function which provides the balance of the financial account is unavailable regardless of the actual status of the function.

20. A method of claim 16 wherein the ATM is housed in a room having a door that is electronically locked to seal the individual in the room when the ATM alarm system is activated by the security code.
